(19) United States
(12) Patent Application Publication
(10) Pub. No.: US 2015/0161007 A1
(43) Pub. Date: Jun. 11, 2015

(54) CONTACT PERSON BACKUP METHOD, DEVICE AND STORAGE MEDIUM FOR MOBILE TERMINAL

(71) Applicant: Tencent Technology (Shenzhen) Company Limited, Guangdong (CN)

(72) Inventor: Xueying Yang, Guangdong (CN)

(73) Assignee: Tencent Technology (Shenzhen) Company Limited

(21) Appl. No.: 14/625,716

(22) Filed: Feb. 19, 2015

Related U.S. Application Data
(63) Continuation of application No. PCT/CN2013/083234, filed on Sep. 10, 2013.

(30) Foreign Application Priority Data
Sep. 19, 2012 (CN) 201210347703.2

(51) Int. Cl. G06F 11/14

(52) U.S. Cl. CPC G06F 11/1412

(57) ABSTRACT

In the present invention, the method comprises: reading contact person data from a mobile terminal, the contact person data containing text messages and images; determining whether to back up the image or not; if so, storing the text messages about and the images of the contact person data into a remote server; and if not backing up the images, storing the text messages about the contact person data into the remote server. The present invention avoids unnecessary traffic waste.

### CROSS REFERENCE TO RELATED APPLICATIONS

This application is a U.S. continuation application under 35 U.S.C. §111(a) claiming priority under 35 U.S.C. §§120 and 365(c) to International Application No. PCT/CN2013/083234 filed Sep. 10, 2013, which claims the priority benefit of Chinese Patent Application No. 201210347703.2 filed Sep. 19, 2012, the contents of which are incorporated by reference herein in their entirety for all intended purposes.

### FIELD

The disclosure relates to the field of mobile terminal data backup, and particularly to a method, a device and a storage medium for backing up contact person data of a mobile terminal to a remote server.

### BACKGROUND

With the gradually popularization of mobile communication devices (such as smartphones and tablet personal computer), the demand for data backup of the mobile communication devices is growing. It is a better solution of storing user data of the mobile communication devices to a remote server, which is one of the reasons of the cloud industry booming.

It is basic for the user to store contact lists of the mobile communication devices to the remote server (or Cloud server) in user data backup. For the existing contact list sync software, there are two technical solutions to achieve: the first prior art solution only backs up text messages of the contact persons; the second prior art solution backs up integration information combining the text messages and images (or avatars) of the contact persons.

Drawbacks of the first prior art solution are that the image of the contact persons cannot be backed up, and the text messages of all contact persons needs to be uploaded to the remote server every time one of the text messages needs to be backed up, which results in a waste transfer traffic. Drawbacks of the second prior art solutions are that when a lot of images needs to be backed up, backup speed is very slow, and the text messages and the images of all contact persons need to be uploaded to the remote server every time one of the text messages or the images needs to be backed up, which consumes unnecessary waste flow.

### SUMMARY

Exemplary embodiments of the present invention provide a method, a device and a storage medium for backing up contact persons of a mobile terminal, to improve a speed of backing up the contact persons of the mobile terminal, which avoids unnecessary waste flow.

One embodiment of the present invention provides a method for backing up contact person data of a mobile terminal, including:

obtaining text messages recorded in an electronic business card of the mobile terminal, wherein the electronic business card is formed by converting original contact person data, the original contact person data include the text message and images, each text message includes a contact person account;

calculating a first data detection value of the text message corresponding to each contact person account;

generating a first mapping table of the first data detection values and the contact person accounts;

comparing the first mapping table to a predetermined mapping table stored in the mobile terminal, to filter first special contact person data of which the text messages are changed;

obtaining the images from the electronic business card;

calculating a second data detection value of the image corresponding to each contact person account;

generating a second mapping table of the second data detection values and the contact person accounts;

comparing the second mapping table to the predetermined mapping table, to filter second special contact person data of which the images are changed; and

determining whether the images are backed up, wherein if the images are backed up, the text messages corresponding to the first special contact person data and the images corresponding to the second special contact person data are stored into a remote server, if the images fail to be backed up, the text messages corresponding to the first special contact person data are stored into the remote server.

Another embodiment of the present invention provides a method for backing up contact person data of a mobile terminal, including:

obtaining the contact person data of the mobile terminal, wherein the contact person data include text messages and images;

determining whether the images are backed up;

storing the text messages and the images of the contact person data into a remote server, if it determines that the images are backed up; and

storing the text message of the contact person data to the remote server, if it determines that the images fail to be backed up.

Yet another embodiment of the present invention provides a method for backing up contact person data of a mobile terminal, including:

obtaining the contact person data of the mobile terminal, wherein the contact person data include text messages and images, wherein each text message includes a contact person account;

calculating a first data detection value of the text message corresponding to each contact person account, and generating a first mapping table of the first data detection values and the contact person accounts;

calculating a second data detection value of the image corresponding to each contact person account, and generating a second mapping table of the second data detection values and the contact person accounts;

comparing the first and second mapping tables to a predetermined mapping table stored in the mobile terminal, to filter first special contact person data of which the text messages are changed and second special contact person data of which the images are changed; and

determining whether the images are backed up, wherein if the images are backed up, the text messages corresponding to the first special contact person data and the images corresponding to the second special contact person data are stored into a remote server; if the images fails to be backed up, the text messages corresponding to the first special contact person data are stored into the remote server.

Yet another embodiment of the present invention provides a method for backing up contact person data of a mobile terminal, applied in a process of backing up contact person data of contact list of a mobile terminal to a remote server for non-first time, the method including:

obtaining text messages of the contact person data from the mobile terminal, wherein each text messages includes a contact person account;

calculating a first data detection value of the text message corresponding to each contact person account;

generating a first mapping table of the first data detection values and the contact person accounts;

comparing the first mapping table to a predetermined mapping table stored in the mobile terminal, to filter first special contact person data of which the text messages are changed;

determining whether images of the contact person data are backed up;

obtaining the images from the mobile terminal;

calculating a second data detection value of the image corresponding to each contact person account;

generating a second mapping table of the second data detection values and the contact person accounts;

comparing the second mapping table to a predetermined mapping table stored in the mobile terminal, to filter second special contact person data of which the images are changed; and

storing the text messages corresponding to the first special contact person data and the images corresponding to the second special contact person data into the remote server, if the images are backed up;

storing the text messages corresponding to the first special contact person data to the remote server, if the images fail to be backed up.

Yet another embodiment of the present invention provides a method for backing up contact person data of a mobile terminal, applied in a process of backing up contact person data of contact list of a mobile terminal to a remote server for non-first time, the method including:

obtaining text messages of the contact person data from the mobile terminal, wherein each text message includes a contact person account;

calculating a first data detection value of the text message corresponding to each contact person account;

generating a first mapping table of the first data detection values and the contact person accounts;

comparing the first mapping table to a predetermined mapping table stored in the mobile terminal, to filter first special contact person data of which the text messages are changed;

storing the text messages corresponding to the first special contact person data into a remote server;

determining whether images of the contact person data are backed up;

obtaining the images from the mobile terminal; wherein if the images are backed up, the method further includes:

calculating a second data detection value of the image corresponding to each contact person account;

generating a second mapping table of the second data detection values and the contact person accounts;

comparing the second mapping table to a predetermined mapping table stored in the mobile terminal, to filter second special contact person data of which the images are changed; and

storing the images corresponding to the second special contact person data to the remote server.

Yet another embodiment of the present invention provides a backup device for backing up contact person data of a mobile terminal, including:

an obtaining module configured to obtain the contact person data of the mobile terminal, wherein the contact person data include text messages and images, each text message includes a contact person account;

a calculating module configured to receive the text messages and the images from the obtaining module, to calculate a first data detection value of the text message corresponding to each contact person account and a second data detection value of the image corresponding to each contact person account;

a generation module, coupled with the calculation module, to generate a first mapping table of the first data detection values and the contact person accounts, and a second mapping table of the second data detection values and the contact person accounts;

a comparison module configured to compare the first and second mapping tables to a predetermined mapping table stored in the mobile terminal, to filter first special contact person data of which the text messages are changed, or filter second special contact person data of which the images are changed;

a determination module configured to determine whether the images are backed up according to indications of users; and

a transmission module configured to transmit the text messages of the first special contact person data to the remote server, or transmit the images of the second special contact person data to the remote server, or transmit the text messages of the first special contact person data and the images of the second special contact person data to the remote server at the same time according to a determination result from the determination module.

Yet another embodiment of the present invention provides a storage medium, storing one or more programs for execution by one or more processors of a computer having a display, the one or more programs including instructions for:

obtaining contact person data from a mobile terminal, wherein the contact person data includes text messages and images;

determining whether the images are backed up;

storing the text messages and the images into a remote server if the images are backed up; and

storing the text messages into a remote server if the images fail to be backed up.

In exemplary embodiments of the present invention, compared to the prior art, the technical solutions of the embodiments can respectively back up the text messages of the contact person data and the images of the contact persons during the process of backing up the contact person data of the mobile terminal 11 to the remote server 12, to make the image backup become a selectable option. Therefore, during the whole backup process, it can avoid unnecessary traffic waste. On the other hand, the embodiment can only back up the text messages or the images of the special contact person data of which the text messages or images are changed, which enhances the backup speed, and brings a better user experience.

### BRIEF DESCRIPTION OF THE DRAWINGS

In order to illustrate technical solutions according to embodiments of the disclosure, a brief description of drawings that assists the description of embodiments of the invention or existing art will be provided below. It would be apparent that the drawings in the following description are only for some of the embodiments of the invention.

FIG. 1 is a running environment schematic diagram of an example of a method for backing up contact persons of a mobile terminal according to various embodiments;

FIG. 2 is a flowchart of an example of a method for backing up contact persons of a mobile terminal according to various embodiments;

FIG. 3 is a flowchart of a preferably example of a method for backing up contact persons of a mobile terminal according to various embodiments;

FIG. 4 is a flowchart of an example of a user backing up data of contact persons for the first time according to various embodiments;

FIG. 5 is a flowchart of an example of a user backing up data of contact persons for the non-first time according to various embodiments;

FIG. 6 is a flowchart of another example of a user backing up data of contact persons for the non-first time according to various embodiments;

FIG. 7 is a structure diagram of an example of a backup device for backing up contact persons of a mobile terminal according to various embodiments.

### DETAILED DESCRIPTION OF ILLUSTRATED EMBODIMENTS

In the following description, embodiments of the invention with reference to symbols and steps performed by one or more computers are described, unless stated otherwise. Therefore, that these steps and operations are mentioned to be performed by a computer several times. The computer performance mentioned hereinto includes an operation performed by a computer processing unit, which processes electronic signals representative of a structured data type in the operation of a computer processing unit. This operation converts the data or maintains its position in a memory system of the computer, which can be reconfigured or otherwise ways known to the skilled person to change the operation of the computer. A data structure maintained by the data is a physical location of a data memory. The physical location of the data memory has the specific properties defined by data format. However, the above-mentioned contents only describes the principles of the invention, as it does not represent a limitation, the skilled person can aware that the various steps described below may be implemented in hardware.

The principles of the invention have used many other specific or generic operations, communication environments or configurations to operate. Well-known examples of operation systems, the environments, and configuration, which are suitable for the present invention, may include (but are not limited to) handheld phones, personal computers, servers, multiprocessor systems, microprocessor-based systems, the main architecture type computers, and distributed computing environment, which includes any of the above-mentioned systems or devices.

As used herein, the term “module” may be considered as software objects executed on the computing system. Different components, modules, engines, and servers, which are described herein, are considered as implementation objects on the computing system. Preferably, the apparatus and the methods described herein are implemented in a software manner. In the other embodiments, the apparatus and the methods also can be implemented in hardware, which are in the protection scope of the present invention.

The invention provides one of the technical solutions can achieve backing up the contact persons recorded in the contact lists of the mobile terminals (such as smart phones, tablet PCs, etc.) to a remote (or cloud) server. Text messages of the contact person and the images (or avatars) of the contact persons can be backed up separated. The user can determine whether the images of the contact persons are backed up. Therefore, it saves flow consumed during a backup process. On the other hand, during the backup process, the user can only back up changed text messages or images of the contact persons. Therefore, it effectively avoids the unnecessary waste of traffic, and improves a backup speed.

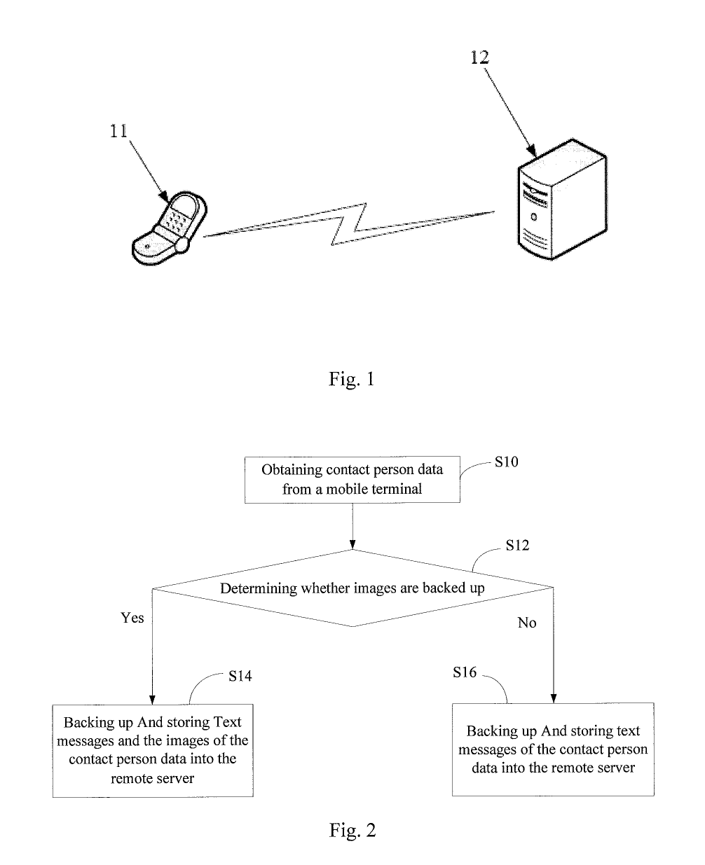

Referring to FIG. 1, it is a running environment schematic diagram of an embodiment of a method for backing up contact persons of a mobile terminal. The running environment schematic diagram shows a mobile terminal 11 and a remote server 12. The mobile terminal 11 is connected to the remote server 12 through internet. The mobile terminal 11 can upload contact person data stored in the mobile terminal 11 to the remote server 12. The remote server 12 stores the contact person data. The contact person data include text messages and images.

The mobile terminal 11 may be a desktop computer. The mobile terminal 11 also may be a terminal with storage units, microprocessors, and operation capability. The terminal may be a notebook computer, a workstation, a palmtop computer, a ultra mobile personal computer (UMPC), a tablet personal computer, a personal digital assistant (PDA), a web pad, a portable telephone, and so on.

The internet may includes a data communication network which includes a local area network (LAN), a metropolitan area network (MAN), a wide area network (WAN). The internet further includes a telephone network. The above-mentioned networks may be wire or wireless networks, and can use any communication mode.

Referring to FIG. 2, it is a flowchart of an example of a method for backing up contact persons of a mobile terminal according to an embodiment. Generally, contact person data of a contact list of the mobile terminal 11 includes text messages and images. The text messages may be names, telephone numbers, addresses, email addresses, and personal homepages of the contact persons. The images may be avatars or photos of the contact persons. The main flow of the contact person data being backed up to the remote server 12 is as follows.

Step 10, obtaining the contact person data from the mobile terminal 11. In the step 10, obtaining original contact person data stored in the mobile terminal 11 directly, or obtaining the text messages and images from an electronic business card after converting a format of the original contact person data into a file format of the electronic business card. In addition, if the contact person data are already inherently stored in the mobile terminal 11 in the format of the electronic business card, in the step 10, the contact person data stored in the electronic business card can be obtained directly.

It should be noted that, the file format of the electronic business card may be VCard, which regulates that personal data exchanged in public are allowed. The file format of the electronic business card may be used to be as an exchange format among applications or systems. Users can directly use the VCard on the Internet, e-mail can forward the personal messages stored in VCard, and many tablets filled by the users on the Web can also use the VCard automatically.

Step 12, determining whether the images are backed up. During the backup process, an interface can be provided for the users to check whether the images are backed up. The interface can be placed in a variety of application software to adjust the custom “option”, or when a backup program is executing, a window pops for the user to check whether the images are backed up. If it determines that the images are backed up, a step 14 is executed; if it determines that the images fails to be backed up, a step 16 is executed.

Step 14, backing up the text messages and the images of the contact person data, and storing the text messages and the images of the contact person data into the remote server 12.

Step 16, backing up the text messages of the contact person data, and storing the text messages of the contact person data into the remote server 12.

In the step 14, it is unnecessary for the program of uploading the text messages of the contact person data and the program of uploading the images of the contact person data to be executed in the same program. That is, the text messages of the contact person data can be first uploaded to the remote server 12, and then when the images is determined to be backed up, the images of the contact person data are uploaded to the remote server 12. The programs for uploading the text messages and the images of the contact person data can be appropriate adjusted according to different designs.

During the process of backing up the text messages of the contact person data, the method may further include determining whether one of the text messages corresponding to contact person accounts is changed. That is, the current text messages of the contact person data which is to be backed up is compared with the last text messages of the contact person data which are backed up, to find first special contact person data of which the text messages are changed, and stores the text messages which are changed to the remote server 12.

Specifically, a first data detection value of the text message corresponding to each contact person account of the contact person data which is to be backed up is calculated first. That is, the text message of each contact person data which is to be backed up is detected, to get the corresponding first data detection value. The first data detection value may be checksum or hash sum. The checksum is a check algorithm often used in the field of data storage and communication to ensure data correct, such as MD5 hash function. And then, the first data detection values are compared with first predetermined detection values to find the contact person account which the first data detection value corresponding to is inconsistent with the predetermined value. The found contact person account corresponds to the first special contact person data of which the text message is changed. The first predetermined detection value is a predetermined text detection value stored in the mobile terminal 11.

Similarly, during the process of backing up the images of the contact person data, the method further includes determining whether one of the images corresponding to the contact person accounts is changed. That is, the current images of the contact person data which are to be backed up are compared with the images of the contact person data which are backed up last, to find second special contact person data of which the images are changed, and then the images of the special second contact person data are stored in the remote server.

Specifically, a second data detection value of the image corresponding to each contact person account of the contact person data which are to be backed up is calculated. That is, the image of each contact person data which is to be backed up is detected, to get the second detection value corresponding to each image. And then, the second data detection values are compared with second predetermined detection values, to find special contact person accounts, which the second detection values corresponds to is inconsistent with the second predetermined detection values. The special contact person accounts correspond to the contact person data of which the images are changed. The second predetermined detection values are predetermined image detection values stored in the mobile terminal 11.

During the process of backing up the text messages and images of the contact persons, when a new contact person is added in the original contact list, a text message and image of the new contact person are also backed up to the remote server 12.

Compared to the prior art, the technical solutions of the embodiments can respectively back up the text messages of the contact person data and the images of the contact persons during the process of backing up the contact person data of the mobile terminal 11 to the remote server 12, to make the image backup become a selectable option. Therefore, during the whole backup process, it can avoid unnecessary traffic waste. On the other hand, the embodiment can only back up the text messages or the images of the special contact person data of which the text messages or images are changed, which enhances the backup speed, and brings a better user experience.

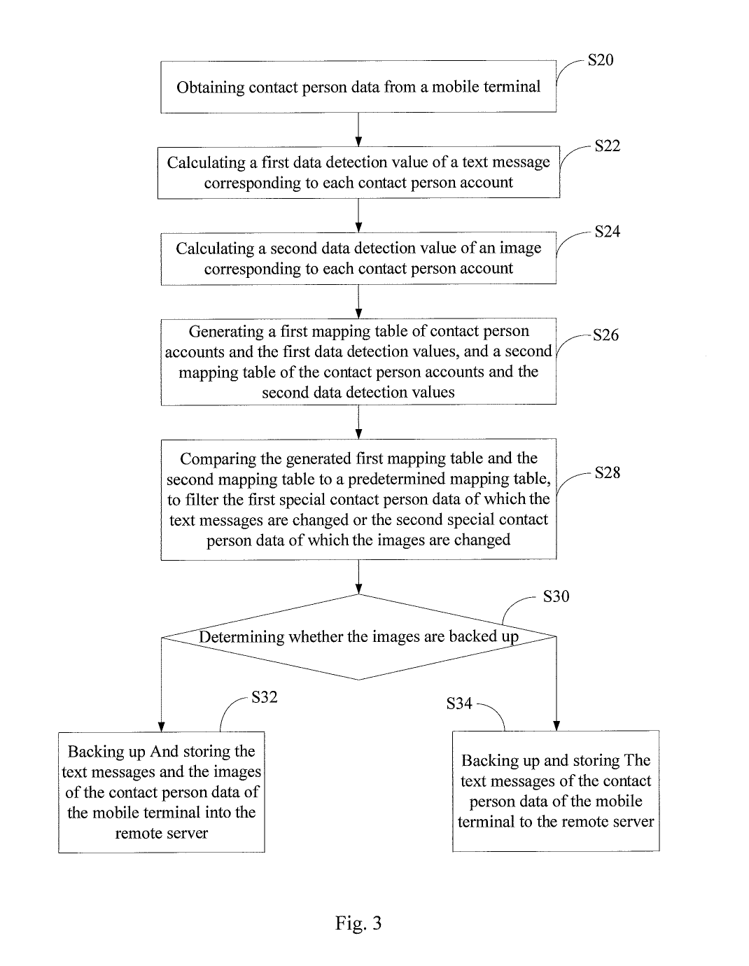

Referring to FIG. 3, it is a flowchart of a preferably example of a method for backing up contact persons of a mobile terminal according to various embodiments. The preferably embodiment can refer to the FIG. 1 and the following descriptions.

Step 20, obtaining contact person data from the mobile terminal 11. The contact person data include the text messages and the images. Hereby, the original contact person data stored in the mobile terminal 11 can be obtained directly, or the contact person data recorded in the electronic business card also can be obtained. The file format of the electronic business card may be VCard.

Step 22, calculating the first data detection value (such as check sum or hash sum) of the text message corresponding to each contact person account. That is, the text message of each contact person data which is to be backed up is detected, to get the first data detection value corresponding to each text message.

Step 24, calculating the second data detection value of the image corresponding to each contact person account. That is, the image of each contact person data which is to be backed up is detected, to get the second data detection value corresponding to each image.

Step 26, generating a first mapping table of the contact person accounts and the first data detection values (see step 22), and a second mapping table of the contact person accounts and the second data detection values (see step 24). The first mapping table records the first data detection value corresponding to each contact person account. The second mapping table records the second data detection value corresponding to each contact person account.

Step 28, comparing the first mapping table and the second mapping table generated in the step 26 to a predetermined mapping table of the mobile terminal 11, to filter the first special contact person data of which the text messages are changed or the second special contact person data of which the images are changed. That is, the first data detection values of the first mapping table and the second data detection values of the second mapping table are compared with predetermined data detection values of the predetermined mapping table. If one of the first data detection values and second data detection values are different from the corresponding predetermined data detection value of the predetermined mapping table, it denotes that the text message or image of the contact person data corresponding to the inconsistent predetermined data detection value is changed. The predetermined mapping table is a mapping table established during the last backup process.

Specifically, in the step 28, the first data detection values of the first mapping table are compared with predetermined text detection values of the predetermined mapping table. Whether the text message of each contact person account is changed can be determined through determining whether one of the first data detection value is consistent with the corresponding predetermined text detection value.

In addition, the second data detection values of the second mapping table are compared with predetermined image detection values of the mapping table. Whether the image of each contact person account is changed can be determined through determining whether one of the second data detection value is consistent with the corresponding predetermined image detection value.

Step 30, determining whether the images are backed up. In the step, whether the images are backed up is determined by a user. If the user determines that the images are backed up, the step 32 is executed. If the user determines that the images are not backed up, the step 34 is executed.

Step 32, backing up the text messages and the images of the contact person data, and storing the text messages and the images of the contact person data of the mobile terminal 11 into the remote server 12.

Step 34, backing up the text messages of the contact person data, and storing the text messages of the contact person data of the mobile terminal 11 to the remote server 12.

In the embodiment, the program of uploading the text messages and the images of the contact person data to the remote server 12 can be appropriately adjusted according to different designs. That is, the program of uploading the images of the contact person data and the program of uploading the text messages of the contact person data may be executed in the different programs.

In addition, it should be note that, in the embodiment, the first mapping table of the first data detection values and the contact person accounts, and the second mapping table of the second data detection values and the contact person accounts are generated before backing up. In the other embodiments, whether the second mapping table of the second data detection values and the contact person accounts is generated after whether the images are backed up.

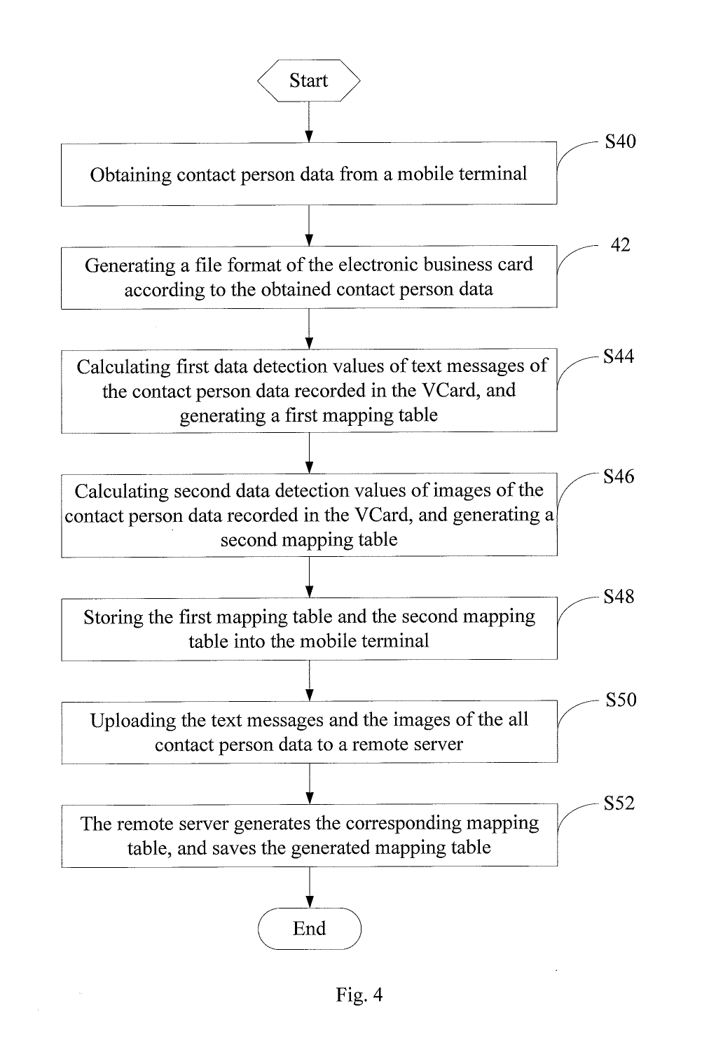

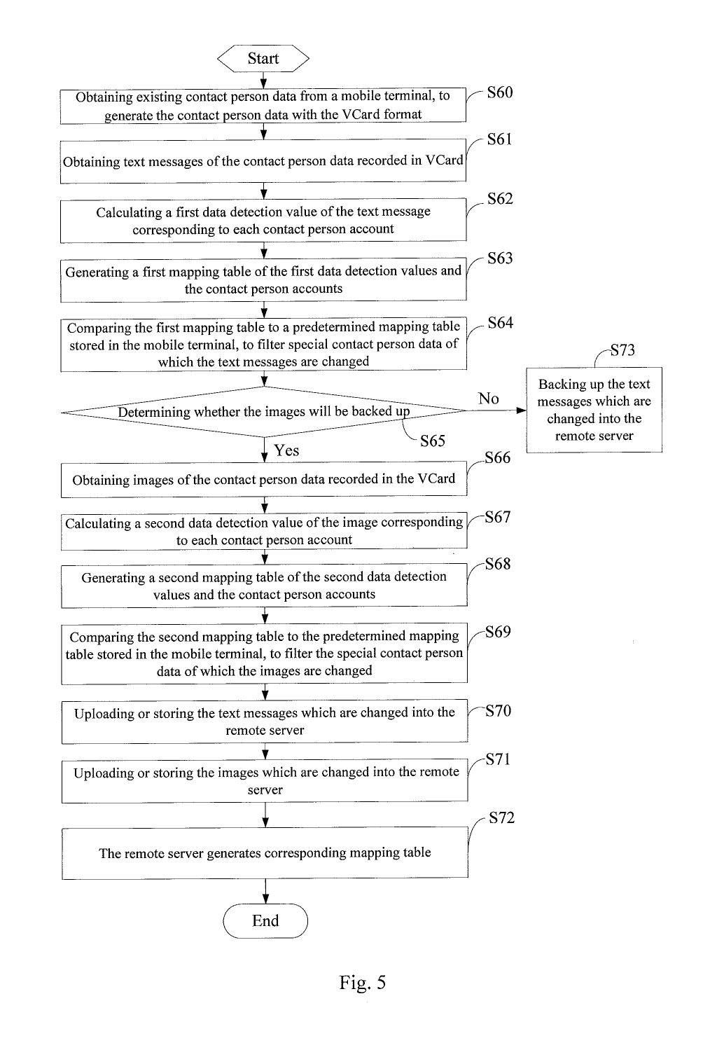

A detailed embodiment is taken as an example to be described below. Referring to FIGS. 4 and 5, FIG. 4 is a flowchart of a user backing up contact person data for the first time. FIG. 5 is a flowchart of the user backing up contact person data for the non-first time.

When the user backs up the contact person data of the contact list of the mobile terminal 11 to the remote server for the first time, it denotes that the contact person data (including the text messages and the images) are stored to the remote server 12. Please reference to the following description with FIG. 3.

Step 40, firstly, obtaining the contact person data from the mobile terminal 11. The contact person data include the text messages and the images.

Step 42, generating the file format of the electronic business card (such as VCard) according to the obtained contact person data in the step 40. If the contact person data have already inherently established in the applications of the mobile terminal 11 in the form of the electronic business card, the step 42 can be omitted.

Step 44, calculating the first data detection values of the text messages of the contact person data recorded in the VCard through using checksum algorithm, and generating the first mapping table of the first data detection values and the contact person data. The first mapping table may be defined as a first detection value mapping table.

Step 46, calculating the second data detection values of the images of the contact person data recorded in the VCard through using the checksum algorithm, and generating the second mapping table of the second data detection values and the contact person data. The second mapping table may be defined as a second detection value mapping table.

It should be noted that, in the steps 44 and 46, the first mapping table and the second mapping table may be independent, or may be combined into one mapping table, which is named a mapping table or existing mapping table.

Step 48, storing the first mapping table generated in the step 44 and the second mapping table generated in the step 46 to a memory of the mobile terminal 11, to be as the existing mapping table.

Step 50, uploading the text messages and the images of the all contact person data recorded in the VCard to the remote server 12.

Step 52, the remote server 12 generates the corresponding mapping table by using the checksum algorithm used in the steps 44 and 46, and saves the generated mapping table.

Referring to FIG. 5, when the user backs up the contact person data for the non-first time, for example, the user backs up the contact person data for the second time, special contact persons whose data are changed can be found out through comparing the mapping table generated during the last backup process with the mapping table generated during the backup process this time. The data of the special contact person are uploaded to the remote server 12. The detail description is as follows.

Step 60, obtaining the existing contact person data from the mobile terminal 11, to generate the contact person data with the VCard format. If the contact person data with the electronic business card format inherently have been established in the applications of the mobile terminal 11, the step 60 can be omitted.

Step 61, obtaining the text messages of the contact person data recorded in the VCard.

Step 62, calculating the first data detection value of the text message corresponding to each contact person account by using the checksum algorithm That is, the text messages of the contact person data which will be backed up is detected, to get the first data detection values of the corresponding text messages.

Step 63, generating the first mapping table of the first data detection values and the contact person accounts. The first mapping table records the first data detection value corresponding to each contact person account.

Step 64, comparing the first mapping table generated in the step 63 to the predetermined mapping table (or the mapping table generated during the last backup) stored in the mobile terminal 11, to filter the special contact person data of which the text messages are changed. Specifically, in the step 64, comparing the first data detection values of the text messages in the first mapping table with the predetermined text detection values of the predetermined text messages in the predetermined mapping table, and determining whether the first data detection values are consistent with the predetermined text detection values of the predetermined text messages, to determine whether the text message corresponding to each contact person account is changed.

Step 65, determining whether the images will be backed up. That whether the images are backed up is determined by the user. If it determines that the images will be backed up, the step 56 is executed. If it determines that the image will not be backed up, the step 63 is executed, it means only the special contact person data of which the text messages are changed are backed up.

Step 66, obtaining the images of the contact person data recorded in the VCard.

Step 67, calculating the second data detection value of the image corresponding to each contact person account by using the checksum algorithm. That is, the image of each contact person data which will be backed up is detected, to get the second data detection values of the corresponding images.

Step 68, generating the second mapping table of the second data detection values and the contact person accounts. The second mapping table records the second data detection value corresponding to each contact person account.

Step 69, comparing the second mapping table generated in the step 68 to the predetermined mapping table (or the mapping table generated during the last backup) stored in the mobile terminal 11, to filter the special contact person data of which the images are changed. Specifically, in the step 69, comparing the second data detection values of the images in the second mapping table with the predetermined image detection values in the predetermined mapping table, and determining whether the second data detection values are consistent with the predetermined image detection values, to determine whether the image corresponding to each contact person account is changed.

Step 70, uploading or storing the text messages which are changed and got in the step 64 into the remote server 12.

Step 71, uploading or storing the images which are changed and got in the step 69 into the remote server 12.

Step 72, the remote server 12 generates the corresponding mapping table by using the checksum algorithm used in the steps 62 and 67.

Step 73, backing up the text messages of the special contact person data of which the text messages are changed into the remote server 12.

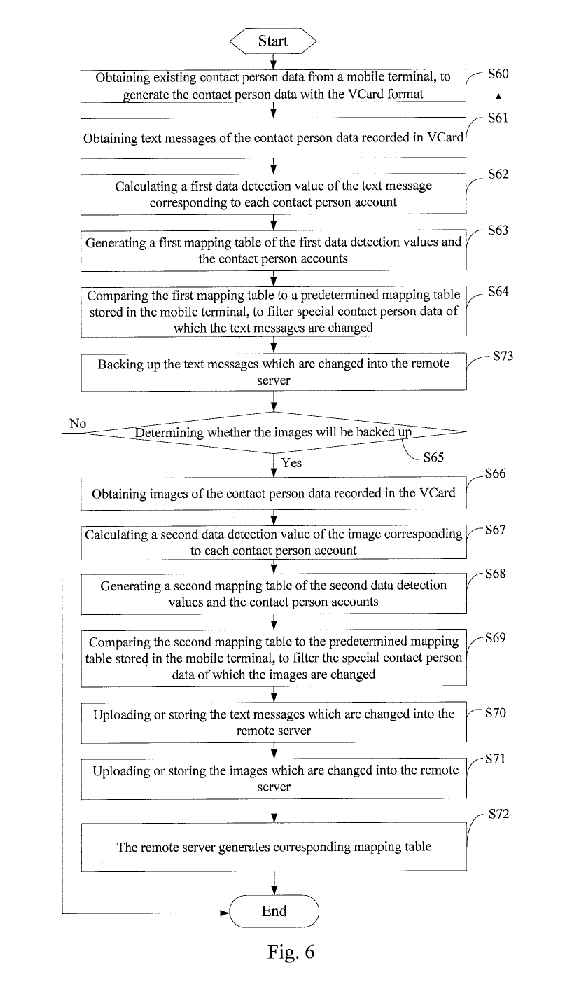

During the backup process of the embodiments, the changed text messages are uploaded to the remote server 12 after determining whether the images are backed up. In the other embodiments, the changed text messages can be uploaded to the remote server 12 before determining whether the images are backed up, as shown in FIG. 6.

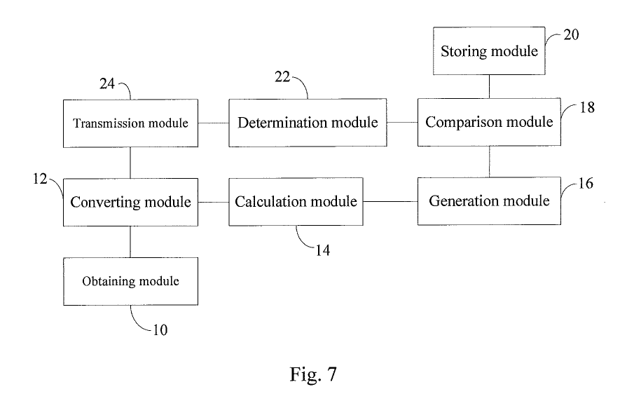

Referring to FIG. 7, it is a structure diagram of a backup device for backing up contact person data of a mobile terminal. The backup device includes an obtaining module 10, a converting module 23, a calculating module 14, a generation module, a comparison module 18, a storing module 20, a determination module 22, and transmission module 24.

The obtaining module 10 is used to obtain the contact person data from the mobile terminal 11, to obtain the text messages of the images of the contact person data. The converting module 12 is coupled between the obtaining module 10 and the calculation module 14, to convert the contact person data obtained by the obtaining module 10 into the file format of the electronic business card, such as VCard. If the contact person data are already inherently stored in the applications of the mobile terminal 11 in the format of the electronic business card, the obtaining module 10 can obtain the contact person data from the VCard indirectly. The calculation module 14 is used to receive the text messages and the images from the obtaining module 10, to calculate the first data detection values corresponding to the contact person accounts and the second data detection values corresponding to the contact person accounts.

The generation module 16 is coupled to the calculation module 14, to generate the first mapping table of the contact person accounts and the first data detection values, and the second mapping table the contact person accounts and the second data detection values. The comparison module 18 is used to compare the first mapping table and the second mapping table generated by the generation module 16 with the predetermined mapping table (the mapping table generated during the last back process) of the mobile terminal 11, to filter the special contact person data of which the text messages or the images are changed. The predetermined mapping table is a mapping table stored in the storing module 20 in advance. The storing module 20 may be a memory or storage. Specifically, the comparison module 18 is used to compare the first data detection values of the first mapping table and the second data detection values of the second mapping table with predetermined text detection values of the predetermined mapping table, to determine whether the text message corresponding to each contact person account is change. The comparison module 18 is also used to compare the second data detection values of the images of the second mapping table with predetermined image detection values of the existing mapping table of the mobile terminal 11, to determine whether the image corresponding to each contact person account is changed. The determination module is used to determine whether the images are backed up according to indication of the users. The transmission module 24 is used to transmit the text messages or images of the special contact person data which is changed to the remote server 12, or transmit the text messages and images of the special contact person data which is changed to the remote server 12 at the same time according to a determination result from the determination module 22.

The comparison between the technical solutions of the embodiments and the above-mentioned second prior art, the following data can be obtained through tests.

TABLE 1

| | The technical solutions | |
|---|---|---|
| | of the embodiments | The second prior art |
| 300 contact persons | 34.7 | 65.9 |
| 600 contact persons | 76 | 138 |
| 1000 contact persons | 133 | 286 |

Backup contact person time comparison chart (unit: seconds)

TABLE 2

| | The technical solutions | |
|---|---|---|
| | of the embodiments | The second prior art |
| 300 contact persons | 731 | 1534 |
| 600 contact persons | 1403 | 2845 |
| 1000 contact persons | 3180 | 6342 |

Backup Contact Person Flow-Consuming Comparison Chart (Unit: KB)

From the above, theory and practice prove that an image separation technology and remote backup based mapping tablet technology not only save time and traffic flow consumed by backing up the contact person data, but also provide a better user experience.

The backup device for backing up the contact person data of the mobile terminal can be installed in a terminal or touch device. The terminal may be a computer, a tablet computer, a mobile phone with touch function, and so on. The backup device for backing up the contact person data of the mobile terminal and the above-mention method for backing up the contact person data of the mobile terminal are belong to the same idea. The backup device for backing up the contact person data can run any method for backing up the contact person data provided by the above embodiments. The detailed process of the backup device running any method for backing up the contact person data can refer to the above-mentioned method for backing up the contact person data of the embodiments.66635867

[symbol]

It should be noted that, a person having ordinary skills in the art can realize that part or whole of the processes in the methods according to the above embodiments may be implemented by a computer program instructing relevant hardware. The program may be stored in a computer readable storage medium. When executed, the program may execute processes in the above-mentioned embodiments of methods. The storage medium may be a magnetic disk, an optical disk, a Read-Only Memory (ROM), a Random Access Memory (RAM), et al.

For the backup device for backing up the contact person data of the mobile terminal, the backup device includes a plurality of function modules. The plurality of function modules can be integrated in one processing chip, or independent of each other. Two or more than two modules of the plurality of function modules can be integrated in a single module. The above integrated modules may be hardware modules or software function module. If the integrated modules are the software function module, and used to be as independent products to be used or sold, the integrated modules also can be stored in the computer readable storage medium. The storage medium may be the read-only memory, the magnetic disk or the optical disk, and so on.

The above descriptions are some exemplary embodiments of the invention, and should not be regarded as limitation to the scope of related claims. A person having ordinary skills in a relevant technical field will be able to make improvements and modifications within the spirit of the principle of the invention. The improvements and modifications should also be incorporated in the scope of the claims attached below.

What is claimed is:

1. A method for backing up contact person data of a mobile terminal, comprising:
obtaining text messages recorded in an electronic business card of the mobile terminal, wherein the electronic business card is formed by converting original contact person data, the original contact person data comprise the text message and images, each text message comprises a contact person account;
calculating a first data detection value of the text message corresponding to each contact person account;
generating a first mapping table of the first data detection values and the contact person accounts;
comparing the first mapping table to a predetermined mapping table stored in the mobile terminal, to filter first special contact person data of which the text messages are changed;
obtaining the images from the electronic business card;
calculating a second data detection value of the image corresponding to each contact person account;
generating a second mapping table of the second data detection values and the contact person accounts;
comparing the second mapping table to the predetermined mapping table, to filter second special contact person data of which the images are changed; and
determining whether the images are backed up, wherein if the images are backed up, the text messages corresponding to the first special contact person data and the images corresponding to the second special contact person data are stored into a remote server, if the images fail to be backed up, the text messages corresponding to the first special contact person data are stored into the remote server.

2. The method of claim 1, further comprising:
obtaining the contact person data of the mobile terminal before obtaining the text message recorded in the electronic business card of the mobile terminal; and
converting a format of the contact person data into a file format of the electronic business card.

3. The method of claim 1, wherein the text messages of the contact person data further comprise at least one of names, telephone numbers, addresses, email addresses, and personal homepages of contact persons of the mobile terminal.

4. A method for backing up contact person data of a mobile terminal, comprising:
obtaining the contact person data of the mobile terminal, wherein the contact person data comprise text messages and images;
determining whether the images are backed up;
storing the text messages and the images of the contact person data into a remote server, if it determines that the images are backed up; and
storing the text message of the contact person data to the remote server, if it determines that the images fail to be backed up.

5. The method of claim 4, further comprising:
determining whether the text messages corresponding to contact person accounts are changed, wherein each text message comprises a contact person account; and
storing the text messages which are changed into the remote server.

6. The method of claim 5, wherein the step of determining whether the text messages corresponding to contact person accounts are changed comprises:
calculating a first data detection value of the text message corresponding to each contact person account; and
comparing the first data detection values to predetermined text detection values stored in the mobile terminal, determining whether the first data detection values are consistent with the predetermined text detection values, wherein if the first data detection values are inconsistent with the predetermined text detection values, it determines that the text messages corresponding to the contact person accounts are changed.

7. The method of claim 4, further comprising:
determining whether the images corresponding to the contact person accounts are changed; and
storing the images which are changed into the remote server, if it determines that the images corresponding to the contact person accounts are changed.

8. The method of claim 7, wherein the step of determining the images of the contact person accounts are changed comprises:
calculating a second data detection value of the image corresponding to each contact person account; and
comparing the second data detection values to predetermined image detection values stored in the mobile terminal, determining whether the second data detection values are consistent with the predetermined image detection values, wherein if the second data detection values are inconsistent with the predetermined image detection values, it determines that the images corresponding to the contact person accounts are changed.

9. The method of claim 4, further comprising:
converting a format of the contact person data into a file format of an electronic business card after obtaining the contact person data from the mobile terminal.

10. The method of claim 4, wherein the text messages of the contact person data further comprise at least one of names, telephone numbers, addresses, email addresses, and personal homepages of contact persons of the mobile terminal.

11. A backup device for backing up contact person data of a mobile terminal, comprising:
an obtaining module configured to obtain the contact person data of the mobile terminal, wherein the contact person data comprise text messages and images, each text message comprises a contact person account;
a calculating module configured to receive the text messages and the images from the obtaining module, to calculate a first data detection value of the text message corresponding to each contact person account and a second data detection value of the image corresponding to each contact person account;
a generation module, coupled with the calculation module, to generate a first mapping table of the first data detection values and the contact person accounts, and a second mapping table of the second data detection values and the contact person accounts;
a comparison module configured to compare the first and second mapping tables to a predetermined mapping table stored in the mobile terminal, to filter first special contact person data of which the text messages are changed, or filter second special contact person data of which the images are changed;
a determination module configured to determine whether the images are backed up according to indications of users; and
a transmission module configured to transmit the text messages of the first special contact person data to the remote server, or transmit the images of the second special contact person data to the remote server, or transmit the text messages of the first special contact person data and the images of the second special contact person data to the remote server at the same time according to a determination result from the determination module.

12. The backup device of claim 11, wherein the comparison module is further configured to compare the first data detection values of the first mapping table generated by the generation module to predetermined text detection values stored in the mobile terminal, and determine whether the first data detection values are consistent with the predetermined text detection values, if the first data detection values are inconsistent with the predetermined text detection values, the text messages corresponding to first data detection values are changed.

13. The backup device of claim 11, wherein the comparison module is further configured to compare the second data detection values of the second mapping table generated by the generation module to predetermined image detection values stored in the mobile terminal, and determine whether the second data detection values are consistent with the predetermined image detection values, if the second data detection values are inconsistent with the predetermined image detection values, the images corresponding to second data detection values are changed.

14. The backup device of claim 11, further comprising:
a converting module coupled between the obtaining module and the calculation module, to convert a format of the contact person data obtained by the obtaining module into a file format of an electronic business card.
